(19) United States
(12) Patent Application Publication
(10) Pub. No.: US 2018/0144644 A1
(43) Pub. Date: May 24, 2018

(54) METHOD AND SYSTEM FOR MANAGING FLIGHT PLAN FOR UNMANNED AERIAL VEHICLE

(71) Applicant: Sharper Shape Oy, Espoo (FI)

(72) Inventors: Tero Heinonen, Jarvenpaa (FI); Ville Koivuranta, Helsinki (FI)

(21) Appl. No.: 15/359,849

(22) Filed: Nov. 23, 2016

(51) Int. Cl. G08G 5/00; B64C 39/02; G05D 1/00; G01S 17/93; G01S 13/90; G01S 19/13

(52) U.S. Cl. CPC G08G 5/0039; B64C 39/024; G08G 5/0034; G01S 19/13; G05D 1/0011; G01S 17/933; G01S 13/90; G08G 5/0069

(57) ABSTRACT

A method for managing a flight plan for an unmanned aerial vehicle. The method includes providing a preliminary flight plan for the unmanned aerial vehicle, flying the unmanned aerial vehicle according to the preliminary flight plan, monitoring a location of the flying unmanned aerial vehicle, executing flight planning actions when the location is proximal to at least one asset, and modifying the preliminary flight plan based on the executed flight planning actions. The preliminary flight plan includes a set of geographical coordinates constituting a flight route of the unmanned aerial vehicle, data related to at least one asset associated with the flight route, and a flight environment model of an environment comprising the at least one asset. The flight planning actions include obtaining information related to at least one asset and a region around the at least one asset, and comparing the obtained information with the flight environment model.

### TECHNICAL FIELD

The present disclosure relates generally to unmanned aerial vehicles; and more specifically, to a method and system for managing a flight plan for an unmanned aerial vehicle.

### BACKGROUND

In recent times, unmanned aerial vehicles (UAVs) such as drones, are increasingly being used for a variety of real world applications. For example, the unmanned aerial vehicles may be used for applications such as surveillance, aerial inspection, aerial photography, disaster relief operations and so forth. Further, nowadays commercial use of the unmanned aerial vehicles for aerial inspection of geographical regions and asset inspection is prevalent. Typically, asset inspection relates to inspection of valuable assets such as real estate, bridges, electricity pylons, and so forth.

Generally, the unmanned aerial vehicles used for asset inspection include a number of sensors (such as image sensors, infrared sensors, proximity sensors, and so forth) mounted thereon. The mounting of such sensors on the unmanned aerial vehicles increases weight thereof. It may be evident that increase in weight of the unmanned aerial vehicles may lower speed thereof and increase consumption of fuel or battery. Further, use of modern technology, such as computer vision technology for collision avoidance, may require specialised processing apparatus which may be difficult to mount within small sized unmanned aerial vehicles. Furthermore, flight plans for asset inspection using the unmanned aerial vehicles may be prepared using pre-acquired data, which may be incorrect (or obsolete). Therefore, a flight route of unmanned aerial vehicles according to such flight plans may not be optimal and may still include risk of collision.

Therefore, in light of the foregoing discussion, there exists a need to overcome the aforementioned drawbacks associated with managing flight plans for unmanned aerial vehicles.

### SUMMARY

The present disclosure seeks to provide a method for managing a flight plan for an unmanned aerial vehicle. The present disclosure also seeks to provide a system for managing a flight plan for an unmanned aerial vehicle. The present disclosure seeks to provide a solution to the existing problem of inefficient flight route management of an unmanned aerial vehicle due to use of obsolete pre-acquired data. An aim of the present disclosure is to provide a solution that overcomes at least partially the problems encountered in prior art, and provides a reliable and easy to implement solution for managing flight plans for unmanned aerial vehicles.

In one aspect, an embodiment of the present disclosure provides a method for managing a flight plan for an unmanned aerial vehicle, the method comprising:
providing a preliminary flight plan for the unmanned aerial vehicle, wherein the preliminary flight plan comprises:
   a set of geographical coordinates constituting a flight route of the unmanned aerial vehicle;
   data related to at least one asset associated with the flight route, wherein the data comprises at least geographical coordinates of each of the at least one asset; and
   a flight environment model of an environment comprising the at least one asset;
flying the unmanned aerial vehicle according to the preliminary flight plan;
monitoring a location of the flying unmanned aerial vehicle;
executing flight planning actions when the location of the unmanned aerial vehicle is proximal to the at least one asset, wherein the flight planning actions comprise:
   obtaining information related to the at least one asset and a region around the at least one asset; and
   comparing the obtained information with the flight environment model; and
modifying the preliminary flight plan based on the executed flight planning actions.

In another aspect, an embodiment of the present disclosure provides a system for managing a flight plan for an unmanned aerial vehicle, the system comprising:
a flight control module operable to:
   provide a preliminary flight plan for the unmanned aerial vehicle, wherein the preliminary flight plan comprises:
      a set of geographical coordinates constituting a flight route of the unmanned aerial vehicle;
      data related to at least one asset associated with the flight route, wherein the data comprises at least geographical coordinates of each of the at least one asset; and
      a flight environment model of an environment comprising the at least one asset;
   fly the unmanned aerial vehicle according to the preliminary flight plan;
   monitor a location of the flying unmanned aerial vehicle;
   execute flight planning actions when the location of the unmanned aerial vehicle is proximal to the at least one asset, wherein the flight planning actions comprise:
      obtaining information related to the at least one asset and a region around the at least one asset; and
      comparing the obtained information with the flight environment model; and
   modify the preliminary flight plan based on the executed flight planning actions; and
a memory unit coupled to the flight control module.

Embodiments of the present disclosure substantially eliminate or at least partially address the aforementioned problems in the prior art, and enables management of a flight plan for an unmanned aerial vehicle.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a schematic illustration of an environment for managing a flight plan for an unmanned aerial vehicle, in accordance with an embodiment of the present disclosure;

FIGS. 2A-2B are illustrations of a system for managing the flight plan for the unmanned aerial vehicle, in accordance with various embodiments of the present disclosure; and

FIG. 3 is an illustration of steps of a method for managing a flight plan for an unmanned aerial vehicle, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

In one aspect, an embodiment of the present disclosure provides a method for managing a flight plan for an unmanned aerial vehicle, the method comprising:
providing a preliminary flight plan for the unmanned aerial vehicle, wherein the preliminary flight plan comprises:
   a set of geographical coordinates constituting a flight route of the unmanned aerial vehicle;
   data related to at least one asset associated with the flight route, wherein the data comprises at least geographical coordinates of each of the at least one asset; and
   a flight environment model of an environment comprising the at least one asset;
flying the unmanned aerial vehicle according to the preliminary flight plan;
monitoring a location of the flying unmanned aerial vehicle;
executing flight planning actions when the location of the unmanned aerial vehicle is proximal to the at least one asset, wherein the flight planning actions comprise:
   obtaining information related to the at least one asset and a region around the at least one asset; and
   comparing the obtained information with the flight environment model; and
modifying the preliminary flight plan based on the executed flight planning actions.

In another aspect, an embodiment of the present disclosure provides a system for managing a flight plan for an unmanned aerial vehicle, the system comprising:
a flight control module operable to:
   provide a preliminary flight plan for the unmanned aerial vehicle, wherein the preliminary flight plan comprises:
      a set of geographical coordinates constituting a flight route of the unmanned aerial vehicle;
      data related to at least one asset associated with the flight route, wherein the data comprises at least geographical coordinates of each of the at least one asset; and
      a flight environment model of an environment comprising the at least one asset;
   fly the unmanned aerial vehicle according to the preliminary flight plan;
   monitor a location of the flying unmanned aerial vehicle;
   execute flight planning actions when the location of the unmanned aerial vehicle is proximal to the at least one asset, wherein the flight planning actions comprise:
      obtaining information related to the at least one asset and a region around the at least one asset; and
      comparing the obtained information with the flight environment model; and
   modify the preliminary flight plan based on the executed flight planning actions; and
a memory unit coupled to the flight control module.

The present disclosure provides a method and system for managing a flight plan for an unmanned aerial vehicle. The method described herein significantly reduces risk of collision between unmanned aerial vehicles and assets during asset inspection. Further, the described system and method may be implemented conveniently for small sized and/or lightweight unmanned aerial vehicles. Furthermore, the method utilises optimal flight planning to significantly reduce costs associated with operation of the unmanned aerial vehicles while also ensuring safe and reliable operation of the unmanned aerial vehicles.

The system for managing a flight plan for an unmanned aerial vehicle comprises a flight control module and a memory unit coupled to the flight control module. In an embodiment, the unmanned aerial vehicle may comprise the flight control module and the memory unit. In another embodiment, a ground control station, which may be communicably coupled to the unmanned aerial vehicle, may comprise the flight control module and the memory unit.

In an embodiment, an unmanned aerial vehicle (or UAV) may be an aircraft without human pilots and/or passengers onboard. Specifically, the unmanned aerial vehicle may be operated fully or partially autonomously for real world applications (or missions) such as asset inspection, aerial photography, and so forth. Optionally, the unmanned aerial vehicle may be operated using on-board computers or remotely located human operators.

According to an embodiment, the unmanned aerial vehicle may comprise at least one sensor coupled to the flight control module. Specifically, the at least one sensor may be a part of payload of the unmanned aerial vehicle. Further, the at least one sensor may be used for missions to be executed by the unmanned aerial vehicle. In an embodiment, the at least one sensor may be one of image sensor, proximity sensor, pressure sensor, motion sensors, radar, LIDAR, acoustic sensors, stereo cameras, and biosensors. It may be evident that the at least one sensor may further include, but is not limited to radiation sensors and infrared sensors. For example, if an unmanned aerial vehicle is operated for aerial inspection of a mountainous region, digital cameras comprising image sensors may be attached to the unmanned aerial vehicle, and coupled to the flight control module.

In an embodiment, a flight plan for the unmanned aerial vehicle is a file comprising information related to a mission of the unmanned aerial vehicle. Specifically, the flight plan may be prepared prior to flight of the unmanned aerial vehicle and may include information related to flight route (or flight trajectory) of the unmanned aerial vehicle. Further, the unmanned aerial vehicle may be operated in accordance with the flight plan. It may be evident that due to absence of humans onboard, adherence to the flight plan for the unmanned aerial vehicle may be critical to success of the mission of the unmanned aerial vehicle.

In an embodiment, the flight control module may be a device for controlling operation of the unmanned aerial vehicle. Specifically, the flight control module may include hardware, software, firmware, or combination of these, suitable for managing the flight plan of the unmanned aerial vehicle. It may be evident that the flight control module may control operation of the unmanned aerial vehicle in accordance with the flight plan.

The flight control module is operable to provide a preliminary flight plan for the unmanned aerial vehicle. In an example, the flight control module may prepare the preliminary flight plan for the unmanned aerial vehicle. In another example, the flight control module may provide access to (or make available for use) a pre-determined preliminary flight plan for the unmanned aerial vehicle. In such example, the pre-determined preliminary flight plan may be prepared at the ground control station, and communicated to the flight control module.

In an embodiment, the preliminary flight plan may be a first version of the flight plan for the unmanned aerial vehicle. Specifically, the preliminary flight plan may be prepared prior to flight of the unmanned aerial vehicle. In an example, the preliminary flight plan may be a high level flight plan such that the preliminary flight plan may be dependent on specifications of the unmanned aerial vehicle and operational environment thereof.

The preliminary flight plan comprises a set of geographical coordinates constituting a flight route of the unmanned aerial vehicle. Specifically, each geographical coordinate (of the set of geographical coordinates) may indicate a geographical location along the flight route of the unmanned aerial vehicle to facilitate navigation along the flight route. It may be evident that the set of geographical coordinates may serve as waypoints along the flight route of the unmanned aerial vehicle. Further, airways between the geographical coordinates may constitute the flight route of the unmanned aerial vehicle. In an embodiment, each geographical coordinate may comprise at least latitude and longitude coordinates. In another embodiment, each geographical coordinate may further comprise altitude information.

Further, the preliminary flight plan comprises data related to at least one asset associated with the flight route. Specifically, the data related to the at least one asset comprises at least geographical coordinates of each of the at least one asset. It may be evident that the geographical coordinates of each of the at least one asset may be/are included in the set of geographical coordinates constituting the flight route of the unmanned aerial vehicle, as described previously. In an example, the at least one asset associated with the flight route may comprise tangible assets such as property, machinery, infrastructure, and so forth.

The preliminary flight plan further comprises the flight environment model of the environment comprising the at least one asset. Specifically, the flight environment model may be a representation of elevation data of the environment comprising the at least one asset. More specifically, the flight environment model may comprise elevation of surface of earth along with elevation of natural or man-made objects (such as mountains, buildings, and so forth) thereon. Further, the flight environment model may comprise representation of waypoints (such as beacons, buoys, and so forth) along the flight route of the unmanned aerial vehicle. Moreover, the flight environment model may comprise a minimum pre-calculated height/altitude to be maintained along the flight route by the unmanned aerial vehicle. For example, a flight environment model of an environment comprising a bridge (asset) includes elevation of the bridge and elevation of mountains, trees and roads present in the environment around the bridge, and beacons along the flight route.

In an embodiment, the flight environment model may be generated using at least one of Light Detection and Ranging (LIDAR) data and Synthetic Aperture Radar (SAR) data. In an example, point cloud data acquired using airborne LIDAR systems may be used for generating the flight environment model. The point cloud data relates to a collection of data points, such as three-dimensional coordinates of external surfaces of objects. In another example, received echoes of radio waves may be processed using a Synthetic Aperture Radar for generating the flight environment model. Specifically, the received echoes of radio waves may be used to create SAR data, namely, high resolution images of the environment comprising the at least one asset. In yet another example, the flight environment model may be generated using both the LIDAR data and SAR data. It may be evident that the flight environment model may be generated prior to flight of the unmanned aerial vehicle. Optionally, the flight environment model may be generated using, but is not limited to, stereo camera data, asset geometry data, and microwave radar scanner data.

According to an embodiment, the generation of flight environment model using the LIDAR data may depend on quality of the LIDAR data. Specifically, quality of the LIDAR data may depend on a variety of parameters including, but not limited to, age of the LIDAR data, density of the point cloud data, and distance between the airborne LIDAR systems and the environment comprising the at least one asset.

In an example, if the LIDAR data used to generate the flight environment model is very old (or aged); the LIDAR data may be obsolete and incorrect. It may be evident that quality of the LIDAR data may be inversely related to age of the LIDAR data. Therefore, appropriate considerations of change (or tolerances) in the environment may be undertaken while generating the flight environment model using such aged LIDAR data. For example, if aged LIDAR data is used for generation of a flight environment model of a forest, increase in height of trees may be taken into account to increase accuracy of the flight environment model.

In another example, density of the point cloud data may be directly related to quality of the LIDAR data. In yet another example, distance between the airborne LIDAR systems and the environment comprising the at least one asset may be inversely related to quality of the LIDAR data. Specifically, if the airborne LIDAR systems are in proximity of the environment, accuracy of captured LIDAR data is higher as compared to accuracy of captured LIDAR data when the airborne LIDAR systems are far from the environment.

According to another embodiment, the generation of flight environment model using the SAR data may depend on quality of the SAR data. Specifically, quality of the SAR data may be related to the generation of the flight environment model in a manner similar to quality of the LIDAR data (as described above).

In an embodiment, the preliminary flight plan may further comprise at least one of planned flight airspeed, planned flight cruising altitude, and payload specification of the unmanned aerial vehicle. According to an embodiment, the preliminary flight plan may further comprise a safe flying distance. Specifically, the safe flying distance may be a minimum distance of separation between the unmanned aerial vehicle and other aerial vehicles or objects along the flight route of the unmanned aerial vehicle. In an example, the safe flying distance may be determined using the flight environment model of the environment comprising the at least one asset. In another example, the safe flying distance may be a default pre-determined distance. It may be evident that the unmanned aerial vehicle may be required to maintain the safe flying distance for collision avoidance.

In an embodiment, the safe flying distance may depend on the quality of at least one of the LIDAR data and the SAR data. Specifically, the safe flying distance may be inversely related to the age of the LIDAR data and/or the SAR data. For example, the safe flying distance may be 150 feet if the LIDAR data is 3 years old, and may be 50 feet if the LIDAR data is 1 years old.

According to an embodiment, the preliminary flight plan may further comprise flight geometry for inspection of the at least one asset. Specifically, the flight geometry may relate to trajectory and/or speed of the unmanned aerial vehicle. For example, the flight geometry for inspection of a building may include a circular or spiral motion of the unmanned aerial vehicle around the building at a speed of 40 knots.

The flight control module is further operable to fly the unmanned aerial vehicle according to the preliminary flight plan. Specifically, the flight control module may be coupled to electromechanical components (such as wings, stabilizers, engine, and so forth) of the unmanned aerial vehicle. The flight control module may control operation of the electromechanical components to fly the unmanned aerial vehicle.

Further, the flight control module is operable to monitor a location of the flying unmanned aerial vehicle. In an embodiment, the unmanned aerial vehicle may comprise a global positioning system to monitor the location of the flying unmanned aerial vehicle. Specifically, monitoring the location ensures compliance with the flight plan of the unmanned aerial vehicle. Further, the monitored location of the unmanned aerial vehicle indicates distance between the unmanned aerial vehicle and the at least one asset. It may be evident that the flight control module may be communicably coupled with the global positioning system to monitor the location of the flying unmanned aerial vehicle.

The flight control module is further operable to execute flight planning actions when the location of the unmanned aerial vehicle is proximal to the at least one asset. In an example, the flight planning actions may be executed when the unmanned aerial vehicle is within a pre-determined radius from the at least one asset. The flight planning actions comprise obtaining information related to the at least one asset and a region around the at least one asset; and comparing the obtained information with the flight environment model.

It may be evident that the region around the at least one asset may relate to an area of the environment in proximity of the asset. For example, an environment (comprising one or more assets) may be 100 square kilometres in size and a region around an asset in such environment may be an area of 500 metres radius around the asset.

According to an embodiment, obtaining information related to the at least one asset and the region around the at least one asset may comprise capturing at least one image of the at least one asset. Specifically, the at least one image of the at least one asset may be captured using image sensors attached to the unmanned aerial vehicle. It may be evident that the at least one image of the asset may include at least a portion of the region around the at least one asset. In an embodiment, the obtained information may further comprise, but is not limited to, geospatial data, atmospheric sensor data, pressure sensor data, infrared sensor data, and radiation detector data.

The flight planning actions further comprise comparing the obtained information with the flight environment model. Specifically, the comparison may be performed to identify inconsistencies (or discrepancies) between the obtained information and the flight environment model. It may be evident to a person skilled in the art that such inconsistencies may have a severe impact on success of the mission of the unmanned aerial vehicle. In an embodiment, the comparison between the obtained information and the flight environment model may be performed using computing units of the flight control module.

Thereafter, the flight control module is operable to modify the preliminary flight plan based on the executed flight planning actions. Specifically, the preliminary flight plan may be modified to accommodate the inconsistencies between the obtained information and the flight environment model. More specifically, the preliminary flight plan may be modified to prepare a modified flight plan. It may be evident that modification of the preliminary flight plan may comprise modification of at least one of the set of geographical coordinates, data related to the at least one asset and the flight environment model. It may also be evident that the preliminary flight plan may not be modified if the comparison between the obtained information and the flight environment model does not yield inconsistencies therebetween.

In an example, the set of geographical coordinates constituting the flight route of the unmanned aerial vehicle may be modified by addition and/or deletion of geographical coordinates to modify (or alter) the flight route. In such example, the flight route may be modified due to inconsistencies such as, but not limited to, construction of objects (such as buildings, bridges), repositioning of the objects, and demolition of the objects along the flight route, subsequent to the forming of the flight environment model, for example based on capture of the LIDAR data (based on which the preliminary flight plan was determined). It may be evident that the flight route may be modified to fly the unmanned aerial vehicle along an updated optimal route in accordance with the obtained information.

In another example, the data related to the at least one asset associated with the flight route may be modified due to various factors including, but not limited to change in asset geometry, and change in asset location subsequent to capture of at least one of the LIDAR data and the SAR data.

In yet another example, the flight environment model may be modified to include the obtained information related to the at least one asset and the region around the at least one asset.

In an embodiment, the preliminary flight plan may be modified if an actual height/altitude of the unmanned aerial vehicle, when flying according to the preliminary flight plan, is less than the height/altitude to be maintained (as mentioned in the flight environment model). In such instance, the height/altitude of the unmanned aerial vehicle may be increased.

According to an embodiment, modifying the preliminary flight plan may comprise changing the safe flying distance of the unmanned aerial vehicle. Specifically, the safe flying distance may be increased or decreased depending on the inconsistencies between the obtained information and the flight environment model. For example, if trees along the flight route of the unmanned aerial vehicle were cut down subsequent to capture of the LIDAR data, the safe flying distance between the unmanned aerial vehicle and ground may be decreased.

In an embodiment, modifying the preliminary flight plan may be based on environmental conditions. Specifically, conditions (or state) of the environment comprising the at least one asset may affect the unmanned aerial vehicle and/or the flight route thereof. Examples of such environmental conditions include, but are not limited to, weather conditions (such as thunderstorms, strong winds, and so forth), presence of birds, and environmental radiation. For example, the preliminary flight plan of the unmanned aerial vehicle may be modified if a thunderstorm develops within the environment comprising the at least one asset.

According to an embodiment, modifying the preliminary flight plan may be based on properties of the unmanned aerial vehicle. Specifically, properties (or characteristics) of the unmanned aerial vehicle may affect operation thereof within the environment. Examples of such properties include, but are not limited to, weight, material, and minimum turning radius of the unmanned aerial vehicle. In an example, a lightweight unmanned aerial vehicle may not be able to withstand strong winds in the environment. Therefore, preliminary flight plan of the lightweight unmanned aerial vehicle may be modified accordingly.

In an embodiment, managing the flight plan for the unmanned aerial vehicle may further comprise flying the unmanned aerial vehicle according to the modified flight plan. Specifically, the flight control module may manage the preliminary flight plan and fly the unmanned aerial vehicle according to the modified flight plan. It may be evident that flying the unmanned aerial vehicle according to the modified plan (based on the executed flight planning actions) may be critical to success of the mission.

According to an embodiment, managing the flight plan for the unmanned aerial vehicle may further comprise executing asset related actions depending on asset specifications. Further, the asset specifications may include, but are not limited to, asset geometry, asset dimensions, and asset's geographical coordinates. Specifically, the flight control module may be operable to execute the asset related actions when the unmanned aerial vehicle is proximal to the at least one asset. Optionally, the asset related actions may be executed when the unmanned aerial vehicle is at a pre-determined distance from the at least one asset. For example, the pre-determined distance may be 50 feet. In an embodiment, the asset related actions comprise at least one of capturing at least one image of the at least one asset, and sensing at least one characteristic of the at least one asset. Specifically, the asset related actions may relate to asset inspection. In another embodiment, the asset related actions comprise adjusting a gimbal to point a gimballed image sensor to a specific point in the asset for capturing a picture. In another embodiment, the asset related actions comprise adjusting a gimbal continuously to point a gimballed image sensor to a specific region of interest of the asset and taking a pictures, video or measurements of the asset. In an example, a gimballed image sensor may be targeted to point at an insulator of a powerline pole to capture images of the insulator. In another example, the gimballed image sensor may be adjusted to point at the powerline pole such that upper structures of the powerline pole are visible at all times in a video capture.

In an example, the captured at least one image of the at least one asset may/may not include the region around the at least one asset. Further, the captured at least one image may be used for close (or detailed) inspection of the asset. It may be evident that the image sensors attached to the unmanned aerial vehicle may be used to capture the at least one image in accordance with the asset related actions.

In another example, the at least one characteristic of the at least one asset may be sensed using the at least one sensor coupled to the flight control module. As described previously, the at least one sensor may be part of the payload of the unmanned aerial vehicle. For example, motion sensors attached to the unmanned aerial vehicle may be used to sense (or recognise) unauthorised activity in and around the at least one asset.

According to an embodiment, the memory unit (of the system for managing the flight plan for the unmanned aerial vehicle) may be configured to store at least one of the preliminary flight plan, the set of geographical coordinates, the data related to at least one asset associated with the flight route, the flight environment model, the obtained information related to the at least one asset and the environment around the at least one asset, the modified flight plan, SAR data and the LIDAR data. Optionally, the memory unit may also be configured to store data related to the executed asset related actions.

In an embodiment, the ground control station may comprise the flight control module and the memory unit. In such embodiment, the ground control station may be communicably coupled to the unmanned aerial vehicle via a network, such as radio network, cellular network, and so forth. Specifically, operation of the unmanned aerial vehicle may be controlled by the ground control station via the communicable coupling therebetween.

It may be evident that the network may be a bidirectional network for facilitation two-way communication therethrough. For example, the network may facilitate communication of the preliminary flight plan, instructions related to the flight planning actions, the modified flight plan, and instructions related to the asset related actions, from the ground control station to the unmanned aerial vehicle. Further, the network may also facilitate communication of the obtained information (related to the at least one asset and the region around the at least one asset), data related to the environmental conditions, and the data related to the executed asset related actions from the unmanned aerial vehicle to the ground control station.

Optionally, the present disclosure provides a computer program product comprising a non-transitory computer-readable storage medium having computer-readable instructions stored thereon, the computer-readable instructions being executable by a computerized device comprising processing hardware to execute the method for managing the flight plan for the unmanned aerial vehicle, described herein above.

### DETAILED DESCRIPTION OF THE DRAWINGS

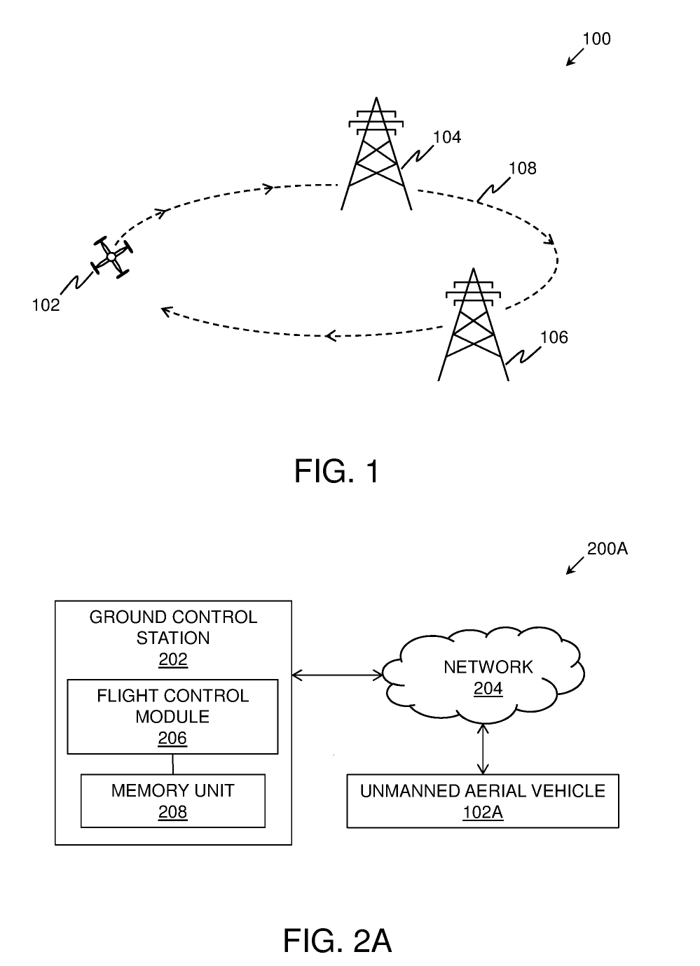

Referring to FIG. 1, illustrated is a schematic illustration of an environment 100 for managing a flight plan for an unmanned aerial vehicle 102, in accordance with an embodiment of the present disclosure. The environment 100 includes the unmanned aerial vehicle 102, and two assets (such as electricity pylons) 104 and 106. The unmanned aerial vehicle 102 flies according to a preliminary flight plan. The preliminary flight plan includes a set of coordinates constituting a flight route 108, geographical coordinates of the two assets 104 and 106, and a flight environment model of the environment 100 comprising the two assets 104 and 106. Further, flight planning actions are executed when the unmanned aerial vehicle 102 is proximal to the two assets 104 and 106. Thereafter, the preliminary flight plan for the unmanned aerial vehicle 102 is modified based on the executed flight planning actions.

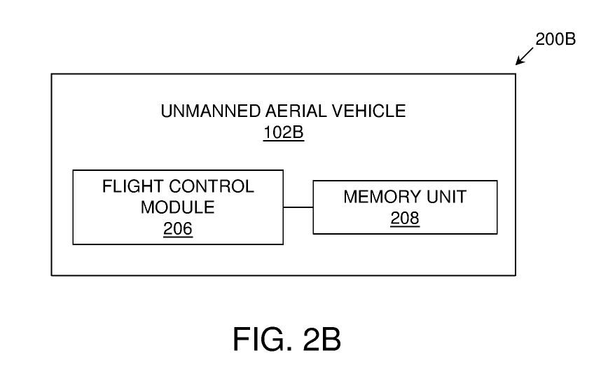

Referring to FIG. 2A, illustrated is a schematic illustration of a system 200A for managing the flight plan for an unmanned aerial vehicle 102A, in accordance with an embodiment of the present disclosure. As shown, the system 200A includes a ground control station 202 communicably coupled to the unmanned aerial vehicle 102A via a network 204. As shown, the ground control station 202 comprises a flight control module 206, and a memory unit 208. The memory unit 208 is coupled to the flight control module 206.

Referring to FIG. 2B, illustrated is a schematic illustration of a system 20013 for managing the flight plan for an unmanned aerial vehicle 10213, in accordance with another embodiment of the present disclosure. As shown, the unmanned aerial vehicle 10213 includes the flight control module 206, and the memory unit 208. The memory unit 208 is coupled to the flight control module 206.

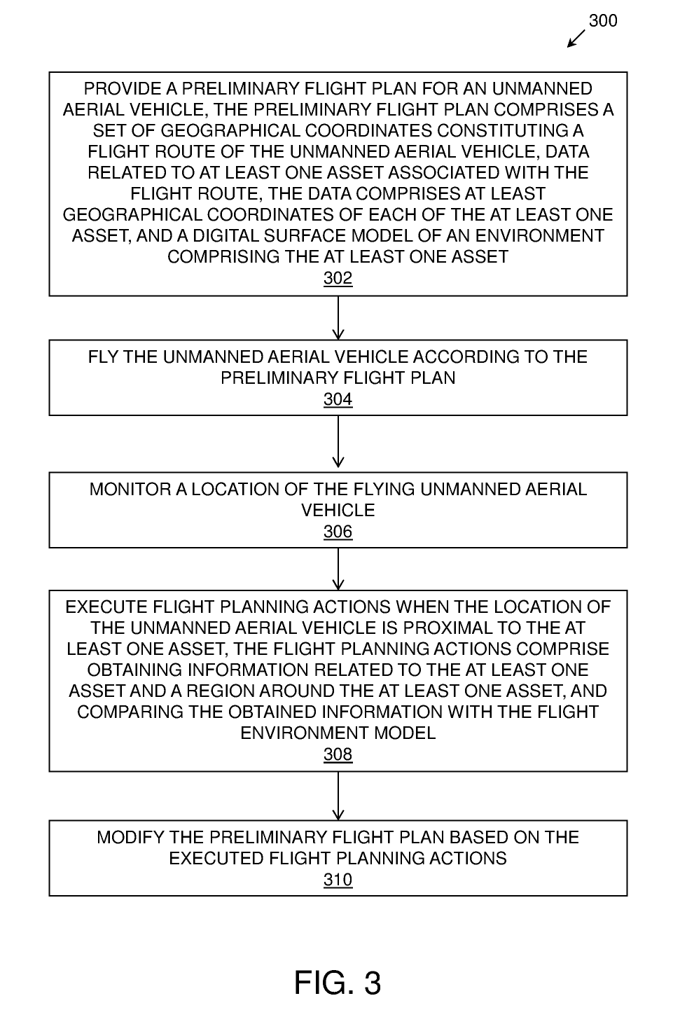

Referring to FIG. 3, illustrated are steps of a method 300 for managing a flight plan for an unmanned aerial vehicle (such as the unmanned aerial vehicle 102, 102A, 10213 of FIGS. 1, 2A, and 2B), in accordance with an embodiment of the present disclosure. At step 302, a preliminary flight plan for an unmanned aerial vehicle is provided, the preliminary flight plan comprises a set of geographical coordinates constituting a flight route of the unmanned aerial vehicle, data related to at least one asset associated with the flight route, the data comprises at least geographical coordinates of each of the at least one asset, and a flight environment model of an environment comprising the at least one asset. At step 304, the unmanned aerial vehicle is flown according to the preliminary flight plan. At step 306, a location of the flying unmanned aerial vehicle is monitored. At step 308, flight planning actions are executed when the location of the unmanned aerial vehicle is proximal to the at least one asset, the flight planning actions comprise obtaining information related to the at least one asset and a region around the at least one asset, and comparing the obtained information with the flight environment model. At step 310, the preliminary flight plan is modified based on the executed flight planning actions.

The steps 302 to 310 are only illustrative and other alternatives can also be provided where one or more steps are added, one or more steps are removed, or one or more steps are provided in a different sequence without departing from the scope of the claims herein. For example, the method 300 may further comprise flying the unmanned aerial vehicle according to the modified flight plan. Optionally, in the method 300, each geographical coordinate may comprise at least latitude and longitude coordinates. In an example, the method 300 may further comprise generating the flight environment model using Light Detection and Ranging (LIDAR) data. In such example, the generation of flight environment model using the LIDAR data may depend on quality of the LIDAR data. Optionally, in the method 300, the preliminary flight plan may further comprise at least one of planned flight airspeed, planned flight cruising altitude, and payload specification of the unmanned aerial vehicle. Further, the preliminary flight plan may comprise a safe flying distance. Optionally, the safe flying distance may depend on the quality of the LIDAR data. Moreover, in the method 300, obtaining information related to the at least one asset and the region around the at least one asset may comprise capturing at least one image of the at least one asset. In an example, the method 300 may further comprise executing asset related actions depending on asset specifications. In such example, the asset related actions may comprise at least one of capturing at least one image of the at least one asset, and sensing at least one characteristic of the at least one asset. Optionally, in the method 300, modifying the preliminary flight plan may comprise changing the safe flying distance of the unmanned aerial vehicle. Optionally, in the method 300, modifying the preliminary flight plan may be based on environmental conditions.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. A method for managing a flight plan for an unmanned aerial vehicle, the method comprising:
providing a preliminary flight plan for the unmanned aerial vehicle, wherein the preliminary flight plan comprises:
a set of geographical coordinates constituting a flight route of the unmanned aerial vehicle;
data related to at least one asset associated with the flight route, wherein the data comprises at least geographical coordinates of each of the at least one asset; and
a flight environment model of an environment comprising the at least one asset;
flying the unmanned aerial vehicle according to the preliminary flight plan;
monitoring a location of the flying unmanned aerial vehicle;
executing flight planning actions when the location of the unmanned aerial vehicle is proximal to the at least one asset, wherein the flight planning actions comprise:
obtaining information related to the at least one asset and a region around the at least one asset; and
comparing the obtained information with the flight environment model; and
modifying the preliminary flight plan based on the executed flight planning actions.

2. A method according to claim 1, wherein the method further comprises flying the unmanned aerial vehicle according to the modified flight plan.

3. A method according to claim 1, wherein each geographical coordinate comprises at least latitude and longitude coordinates.

4. A method according to claim 1, wherein the method further comprises generating the flight environment model using at least one of Light Detection and Ranging (LIDAR) data and Synthetic Aperture Radar (SAR) data.

5. A method according to claim 4, wherein the generation of the flight environment model using at least one of the LIDAR data and SAR data depends on quality of at least one of the LIDAR data and SAR data.

6. A method according to claim 1, wherein the preliminary flight plan further comprises at least one of planned flight airspeed, planned flight cruising altitude, and payload specification of the unmanned aerial vehicle.

7. A method according to claim 1, wherein the preliminary flight plan further comprises a safe flying distance.

8. A method according to claim 7, wherein the safe flying distance depends on the quality of at least one of the LIDAR data and the SAR data.

9. A method according to claim 1, wherein obtaining information related to the at least one asset and the region around the at least one asset comprises capturing at least one image of the at least one asset.

10. A method according to claim 1, wherein the method further comprises executing asset related actions depending on asset specifications.

11. A method according to claim 10, wherein the asset related actions comprise at least one of capturing at least one image of the at least one asset, and sensing at least one characteristic of the at least one asset.

12. A method according to claim 7, wherein modifying the preliminary flight plan comprises changing the safe flying distance of the unmanned aerial vehicle.

13. A method according to claim 1, wherein modifying the preliminary flight plan is based on environmental conditions.

14. A system for managing a flight plan for an unmanned aerial vehicle, the system comprising:
a flight control module operable to:
provide a preliminary flight plan for the unmanned aerial vehicle, wherein the preliminary flight plan comprises:
a set of geographical coordinates constituting a flight route of the unmanned aerial vehicle;
data related to at least one asset associated with the flight route, wherein the data comprises at least geographical coordinates of each of the at least one asset; and
a flight environment model of an environment comprising the at least one asset;
fly the unmanned aerial vehicle according to the preliminary flight plan;
monitor a location of the flying unmanned aerial vehicle;
execute flight planning actions when the location of the unmanned aerial vehicle is proximal to the at least one asset, wherein the flight planning actions comprise:
obtaining information related to the at least one asset and a region around the at least one asset; and
comparing the obtained information with the flight environment model; and
modify the preliminary flight plan based on the executed flight planning actions; and
a memory unit coupled to the flight control module.

15. A system according to claim 14, wherein a ground control station is communicably coupled to the unmanned aerial vehicle, and the ground control station comprises the flight control module and the memory unit.

16. A system according to claim 14, wherein the unmanned aerial vehicle comprises the flight control module and the memory unit.

17. A system according to claim 14, wherein the unmanned aerial vehicle comprises at least one sensor coupled to the flight control module.

18. A system according to claim 17, wherein the at least one sensor is one of image sensor, proximity sensor, pressure sensor, motion sensors, radar, LIDAR, acoustic sensors, stereo cameras, and biosensors.

19. A system according to claim 14, wherein the unmanned aerial vehicle comprises a global positioning system to monitor the location of the flying unmanned aerial vehicle.

20. A system according to claim 14, wherein the memory unit is configured to store at least one of the preliminary flight plan, the set of geographical coordinates, the data related to at least one asset associated with the flight route, the flight environment model, the obtained information related to the at least one asset and the environment around the at least one asset, the modified flight plan, SAR data and LIDAR data.
